(19) United States
(12) Patent Application Publication
(10) Pub. No.: US 2013/0280585 A1
(43) Pub. Date: Oct. 24, 2013

(54) BATTERY STACK

(71) Applicant: HITACHI MAXELL, LTD., Osaka (JP)

(72) Inventors: Rie MORISAKI, Ibaraki-shi (JP); Yukinori MIYAGAWA, Ibaraki-shi (JP); Masatoshi TANAKA, Ibaraki-shi (JP)

(21) Appl. No.: 13/864,657

(22) Filed: Apr. 17, 2013

(30) Foreign Application Priority Data
Apr. 18, 2012 (JP) 2012-094883

(51) Int. Cl. H01M 10/04

(52) U.S. Cl. CPC H01M 10/0436; H01M 10/0413
USPC 429/152

(57) ABSTRACT

A plurality of laminar battery cells and a plurality of plates are alternately disposed and stacked one on top of another. Each battery cell is fixed to an adjacent plate. A rectangle with a minimum area internally including the plate also internally includes the battery cell having a positive electrode tab and a negative electrode tab that are drawn out from the battery cell, when the battery stack is viewed in a stacked direction.

### BACKGROUND OF THE INVENTION

1. Field of the Invention The present invention relates to a battery stack in which a plurality of laminar batteries are stacked.

2. Description of the Related Art

Non-aqueous electrolyte batteries as typified by lithium ion secondary batteries have high energy density, and therefore they are used as power sources for various moving devices such as automobiles and motorbikes, portable personal digital assistant devices, and uninterruptible power supply (UPS) apparatuses. For such applications, in order to further improve energy density, laminate type lithium ion secondary batteries in which a power generation element is sheathed with a flexible laminate sheet are often used. Furthermore, in order to obtain a desired battery capacity, battery stacks in which a plurality of laminar secondary batteries (battery cells) are stacked via insulating sheets therebetween and connected in series are also in practical use (see, for example, Japanese Patent No. 4499977).

A battery stack is accommodated in a container having an accommodation space surrounded by an inner wall having a substantially rectangular solid shape, before use. If, in this state, an impact is applied to the container by being dropped, or vibrations are applied to the container while it is moved, a situation can occur in which the battery cells accommodated in the container collide with the internal wall of the container. As a result, the battery may be deformed, and in the worst case, an accident can occur, such as ignition or explosion of the battery cells.

### SUMMARY OF THE INVENTION

The present invention has been made to solve the problems encountered with conventional technology and it is an object of the present invention to provide a battery stack having improved safety by reducing, with a simple method, the possibility that an external force will be applied directly to the battery cells.

A battery stack according to the present invention is a battery stack in which a plurality of laminar battery cells and a plurality of plates are alternately disposed and stacked one on top of another. Each of the plurality of battery cells is fixed to an adjacent plate. When the battery stack is viewed in a stacked direction, a rectangle with a minimum area internally including the plate also internally includes the battery cell having a positive electrode tab and a negative electrode tab that are drawn out from the battery cell.

### BRIEF DESCRIPTION OF THE DRAWINGS

FIG. 1A is a perspective view of a battery cell constituting a battery stack according to the present invention, as viewed from the front surface side.

FIG. 1B is a perspective view of the same, as viewed from the back surface side.

FIG. 2 is a perspective view of a battery stack according to an embodiment of the present invention.

FIG. 3 is an exploded perspective view illustrating a stack configuration of the battery stack according to an embodiment of the present invention.

FIG. 4 is a front view of the battery stack according to an embodiment of the present invention

FIG. 5 is a perspective view of another battery cell constituting a battery stack according to the present invention, as viewed from the front surface side.

FIG. 6A is a front view of another plate having a battery cell fixed thereto in a battery stack according to the present invention.

FIG. 6B is a front view of still another plate having a battery cell fixed thereto in a battery stack according to the present invention.

FIG. 7A is an exploded perspective view illustrating a stack configuration of a battery stack according to another embodiment of the present invention.

FIG. 7B is a front view of the battery stack shown in FIG. 7A.

### DESCRIPTION OF THE PREFERRED EMBODIMENTS

According to the present invention, it is possible to prevent the battery cells from colliding directly with the inner wall of the container containing the battery stack even if an impact or vibrations are applied to the container. As a result, the possibility that the battery cells will be deformed by such collision or that the battery cells will ignite or explode is reduced. Therefore, according to the present invention, it is possible to provide a battery stack whose safety is improved with a simple method.

In the above-described battery stack according to the present invention, it is preferable that in order to allow the positive electrode tab and the negative electrode tab to be electrically connected between adjacent battery cells, a cut-out is formed in a region of the plate to which the positive electrode tab and/or the negative electrode tab are/is opposed. With this configuration, a plurality of battery cells can be easily connected in series without causing the positive electrode tab and the negative electrode tab that are drawn out from the battery cell to extend beyond the rectangle with the minimum area internally including the plate.

In the above-described battery stack according to the present invention, it is preferable that each side of the rectangle with the minimum area internally including the plate extends 1 mm or more from the battery cell including the positive electrode tab and the negative electrode tab. With this configuration, the safety of the battery stack can be further improved.

Hereinafter, the present invention will be described in detail by way of preferred embodiments. It is to be noted, however, that the present invention is not limited to the following embodiments. In the drawings referred to in the following description, for ease of description, only the principal members required in order to describe the present invention are shown in a simplified form, among the constituent members of the embodiments of the present invention. Accordingly, the present invention may include arbitrary constituent members that are not shown in the drawings referred to hereinafter. Also, the dimensions of constituent members and the dimensional proportions of the members in the drawings are not intended to faithfully represent the actual dimensions of the constituent members and the dimensional proportions of the members.

### (Battery Cell)

First, an overall configuration of a battery cell for use in a battery stack according to the present invention will be described.

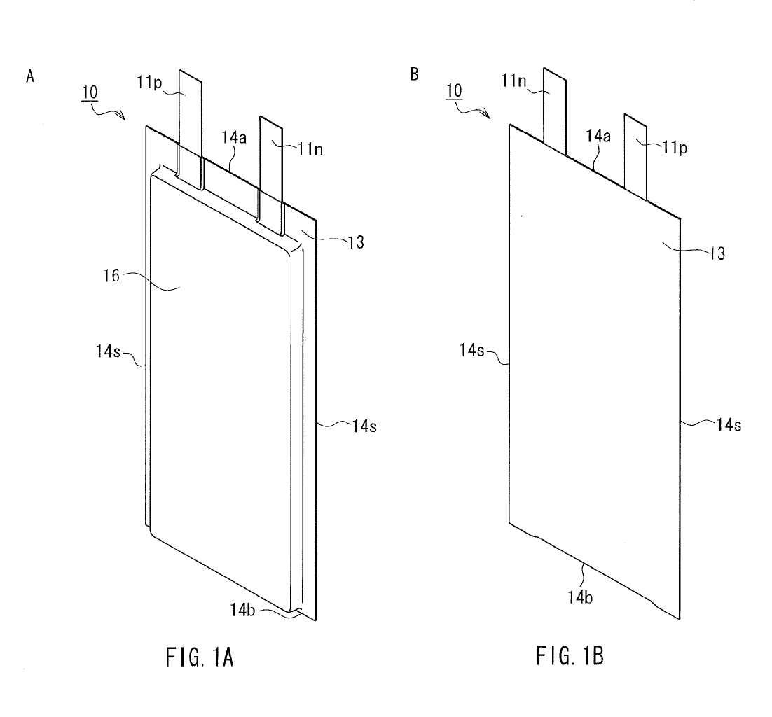

FIG. 1A is a perspective view of a battery cell 10 constituting a battery stack according to the present invention, as viewed from the front surface side. FIG. 1B is a perspective view of the same, as viewed from the back surface side. The battery cell 10 has a substantially rectangular shape in a plan view, and has a laminar shape that is thin relative to the lengthwise and widthwise dimensions of the rectangular shape. In the battery cell 10, a laminar power generation element (not shown) having a rectangular shape in a plan view is enclosed in an outer sheath made of a laminate sheet 13, together with an electrolyte. The power generation element is an electrode stack having positive electrodes and negative electrodes that are alternately stacked one on top of the other with separators interposed therebetween, the positive electrode having a positive electrode material mixture layer containing a positive electrode active material applied and formed on a predetermined region on each surface of a positive electrode current collector, and the negative electrode having a negative electrode material mixture layer containing a negative electrode active material applied and formed on a predetermined region on each surface of a negative electrode current collector. There is no particular limitation on the type of battery, but the type of battery can be secondary battery, and preferably lithium ion secondary battery.

The laminate sheet 13 is thinner than the power generation element and is flexible. The laminate sheet 13 may be, for example, a flexible multilayer sheet in which a heat sealing resin layer (for example, modified polyolefin layer) is laminated on the surface, of a base layer made of aluminum or the like, that opposes the power generation element. A single rectangular laminate sheet 13 is folded in two along a lower end (one of the short sides) 14b so as to sandwich the power generation element, and put together and sealed along the other three sides except for the lower end 14b by heat sealing method or the like.

A positive electrode tab 11p and a negative electrode tab 11n are drawn out from an upper end (the other short side) 14a that opposes the lower end 14b. The positive electrode tab 11p and the negative electrode tab 11n have a strip shape and extend in a direction perpendicular to the upper end 14a (in other words, the direction parallel to a pair of side ends (long sides) 14s that are adjacent to the upper end 14a). The positive electrode tab 11p is made of, for example, an aluminum sheet, and is electrically connected to a plurality of positive electrode current collectors (not shown) constituting the power generation element. Likewise, the negative electrode tab 11n is made of, for example, a copper sheet, a copper sheet plated with nickel, a copper-nickel clad material or the like, and is electrically connected to a plurality of negative electrode current collectors (not shown) constituting the power generation element.

As shown in FIG. 1A, on the front surface side of the battery cell 10, a rectangular region 16 corresponding to the power generation element is protruded from the sealed region of the laminate sheet 13 along three sides 14a, 14s, and 14s of the battery cell 10. On the other hand, as shown in FIG. 1B, the back surface of the battery cell 10 is a substantially flat surface. In the present invention, for ease of description, the surface shown in FIG. 1A on which the rectangular protruding region 16 is formed by the power generation element is referred to as the “front surface” of the battery cell 10, and the surface shown in FIG. 1B that is substantially flat is referred to as the “back surface” of the battery cell 10.

### (Battery Stack)

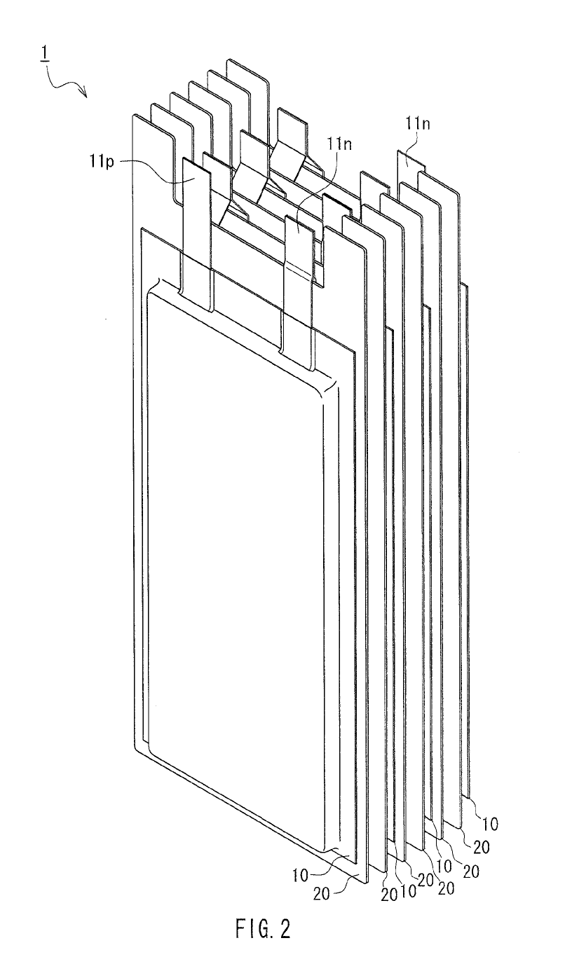

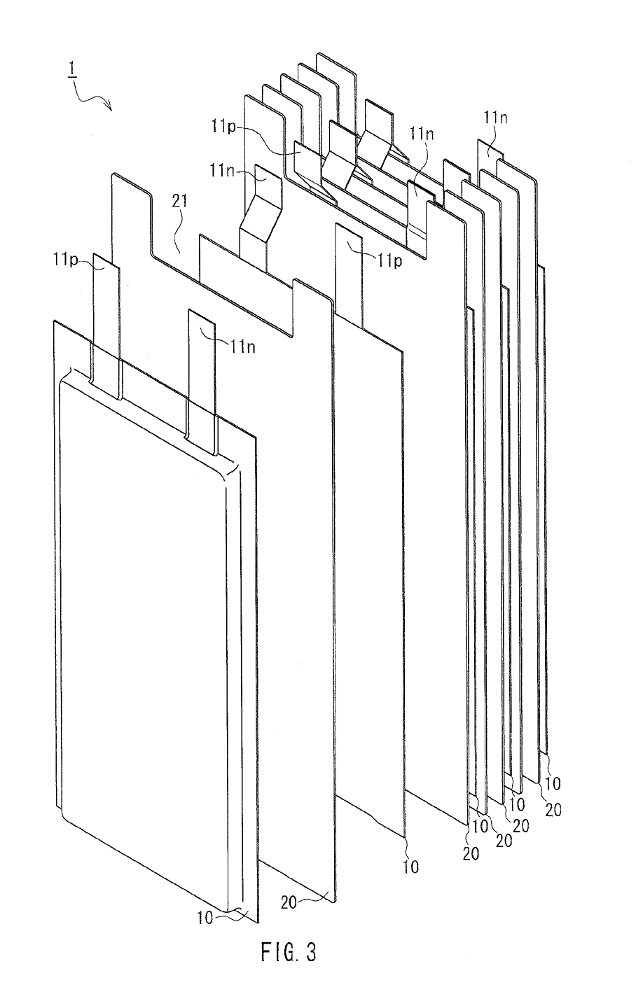

FIG. 2 is a perspective view of a battery stack 1 according to an embodiment of the present invention, and FIG. 3 is an exploded perspective view illustrating a stack configuration of the battery stack 1. As shown in FIGS. 2 and 3, a plurality of (seven in this example) battery cells 10 and a plurality of (six in this example) plates 20 are alternately disposed and stacked one on top of the other. The plurality of battery cells 10 constituting the battery stack 1 have the same shape, and the plurality of plates 20 constituting the battery stack 1 have the same shape. In the present invention, the direction in which the battery cells 10 and the plates 20 are alternately stacked will be referred to as the “stacked direction”.

Each plate 20 has a substantially rectangular shape as a whole. In FIGS. 2 and 3, a cut-out 21 is formed on the upper short side of the plate 20, in a portion other than both ends of the short side, and as a result, a substantially U-shaped edge is formed on the upper side of the plate 20. The plate 20 is made of a hard material that can be regarded as a substantially rigid body. Preferable examples include insulating resin materials such as polycarbonate, and metal materials having excellent thermal conductivity such as copper and aluminum. The plate 20 preferably has, although depending on the material of the plate 20, a thickness of 0.3 mm or more, more preferably 0.5 mm or more, and particularly preferably 0.8 mm or more. The upper limit for the thickness of the plate 20 can be set as appropriate taking into consideration the entire thickness of the battery stack 1, or the like, and is preferably 1.5 mm or less, and more preferably 1.2 mm or less.

Every other battery cell 10 is flipped over so that tabs of different polarities (namely, the positive electrode tab 11p and the negative electrode tab 11n) oppose each other in the stacked direction between two battery cells 10 that are adjacent to each other with a plate 20 interposed therebetween. Thus, the opposing positive electrode tab 11p and negative electrode tab 11n are electrically connected via the cut-out 21 formed in the plate 20 between the battery cells 10 that are adjacent to each other with the plate 20 interposed therebetween. As a result, a plurality of battery cells 10 are connected in series.

Each battery cell 10 is fixed to an adjacent plate 20. Accordingly, a plurality of battery cells 10 and a plurality of plates 20 are integrated into one piece. There is no particular limitation on the fixing method, and it is possible to fix a battery cell 10 to plates 20 by placing a double-sided adhesive tape or adhesive between the front surface of the battery cell 10 and a plate 20 and between the back surface of the battery cell 10 and a plate 20. Particularly, the fixing method using a double-sided adhesive tape is preferable because the stacking step of the battery stack 1 can be performed easily and rapidly.

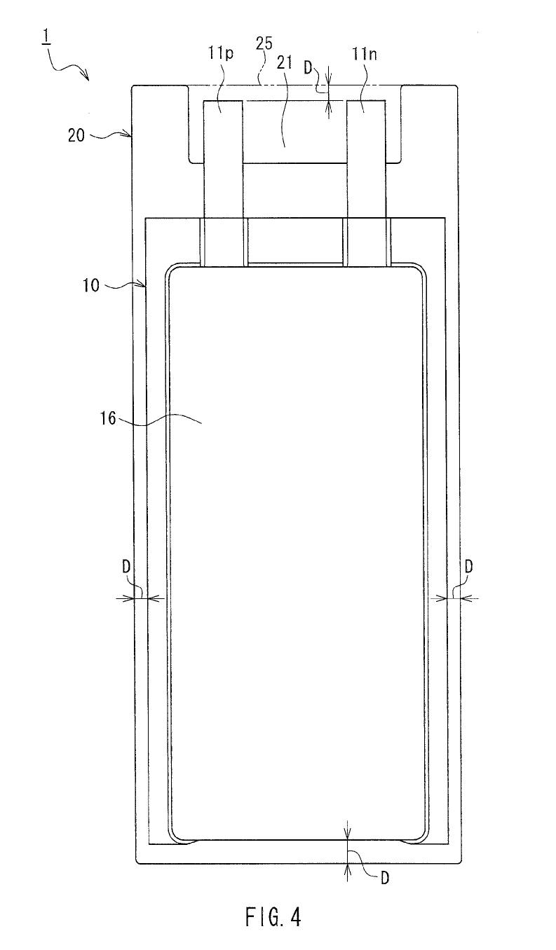

FIG. 4 is a plan view of the battery stack 1, as viewed in the stacked direction. All of the plates 20 constituting the battery stack 1 are positioned such that their projected shapes projected in the stacked direction substantially match with each other.

In FIG. 4, a double-dot-dash line 25 indicates a rectangle with the minimum area internally including the plate 20. Hereinafter, the rectangle indicated by the double-dot-dash line 25 will be referred to as the “contouring rectangle” of the plate 20. In the present embodiment, the contouring rectangle 25 matches the outline of the plate 20, except for the portion where the cut-out 21 is formed. As shown in FIG. 4, the battery cell 10 is internally included in the contouring rectangle 25, together with the positive electrode tab 11p and the negative electrode tab 11n. That is, no parts of the battery cell 10 extend outside beyond the contouring rectangle 25 of the plate 20.

The battery stack 1 of the present embodiment described above is generally accommodated in a container having a space (accommodation space) surrounded by the inner wall having a substantially rectangular solid shape, before use.

Effects of the battery stack 1 of the present invention configured in the above manner will be described.

As described above, in the battery stack 1 of the present invention, each battery cell 10 is fixed to a plate 20. Then, as viewed in the stacked direction, the contouring rectangle 25 of the plate 20 internally includes the battery cell 10 fixed to the plate 20. Accordingly, even if the battery stack 1 moves in a direction perpendicular to the stacked direction within the container as a result of the container containing the battery stack 1 being dropped or vibrated, the plate 20 prevents the battery cell 10 from colliding directly with the inner wall of the container. In this manner, the possibility of an external force being applied directly to the battery cells 10 is reduced, and therefore the possibility of deformation of the battery cells 10 as well as ignition and explosion of the battery cells 10 caused by the deformation can be reduced.

In addition, according to the present invention, the safety of the battery stack 1 can be improved with a very simple method of fixing a battery cell 10 to a plate 20 having a size that can internally include the battery cell 10.

In order to more reliably reduce the possibility of collision of the battery cells 10 with the inner wall of the container, as shown in FIG. 4, it is preferable that the amount D of extension from the battery cell 10 to each side of the contouring rectangle 25 of the plate 20 is large (in other words, the amount of recession of the battery cell 10 from each side of the contouring rectangle 25). The amount D of extension can be set as appropriate according to the strength of the plate 20, or the like. Generally, the amount D of extension is preferably 1 mm or more, more preferably 1.5 mm or more, and particularly preferably 2 mm or more. However, if the amount D of extension is too large, not only further improvement in the safety of the battery stack 1 is not obtained, but also the outer dimensions of the battery stack 1 become large. Generally, the amount D of extension is preferably 4 mm or less, and more preferably 3 mm or less. The amount D of extension to each side of the contouring rectangle 25 may be the same or different.

In FIG. 2, the battery cells 10 disposed on the opposite outer sides in the stacked direction are exposed in the stacked direction, and thus there is a possibility that these battery cells 10 will collide with the inner wall of the container. However, by setting the dimension in the stacked direction of the battery stack 1 to be substantially the same as the inner dimension in the same direction of the container, or by fixing additional plates 20 on the opposite outer sides in the stacked direction, it is possible to reduce the possibility of the occurrence of detrimental deformation caused by the battery cells 10 disposed on the opposite outer sides in the stacked direction colliding directly with the inner wall of the container.

The embodiment described above is merely an example. The present invention is not limited to the above embodiment and can be modified as appropriate.

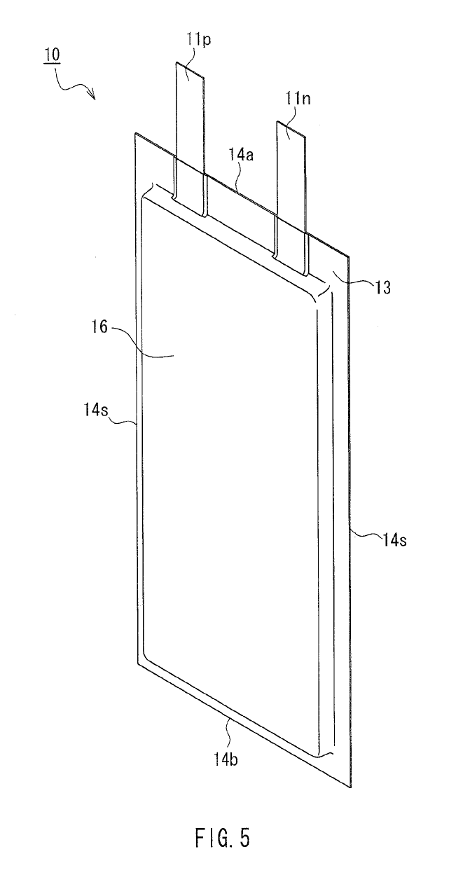

The battery cells 10 of the present invention are not limited to the configuration illustrated in FIGS. 1A and 1B, and may be arbitrary thin battery cells. For example, the battery cell 10 described above is a three-side sealed type battery cell in which a single laminate sheet 13 is folded in two along the lower end 14b, and the laminate sheet 13 is sealed along the three sides except for the lower end 14b, but it may be a four-side sealed type battery cell 10 as shown in FIG. 5 in which the power generation element is sandwiched by two rectangular laminate sheets 13 having the same size and sealing is performed along the four sides including the lower end 14b.

In the battery cell 10 described above, the positive electrode tab 11p and the negative electrode tab 11n are drawn out from the common short side 14a, but the positive electrode tab 11p and the negative electrode tab 11n may be drawn out from either one of a pair of side ends (long sides) 14s. Alternatively, the positive electrode tab 11p and the negative electrode tab 11n may be respectively drawn out from different sides. The size of a plate 20 is set such that the contouring rectangle 25 of the plate 20 internally includes the battery cell 10 including the positive electrode tab 11p and the negative electrode tab 11n, regardless of the drawn-out position of the positive electrode tab 11p and the negative electrode tab 11n. Also, it is preferable that a cut-out is formed in a region of the plate 20 that opposes the positive electrode tab 11p and the negative electrode tab 11n, so that the positive electrode tab 11p and the negative electrode tab 11n can be electrically connected between adjacent battery cells.

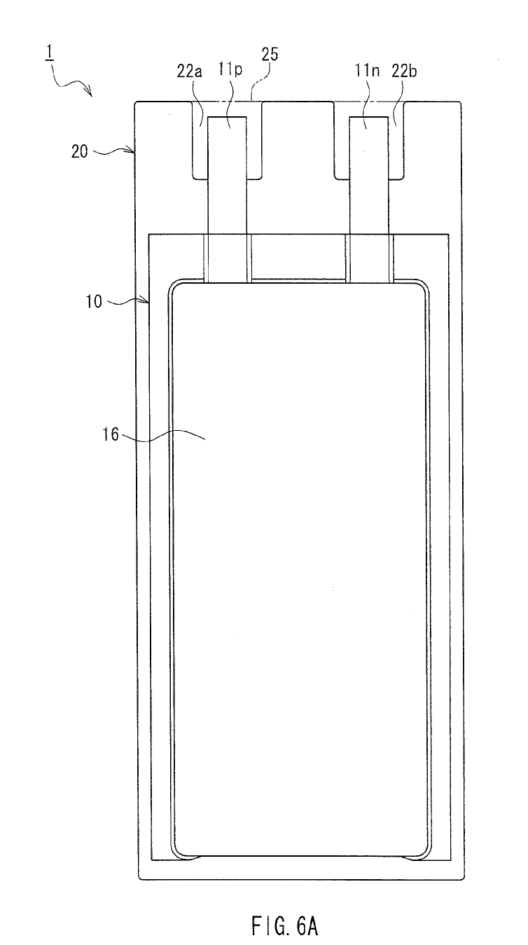

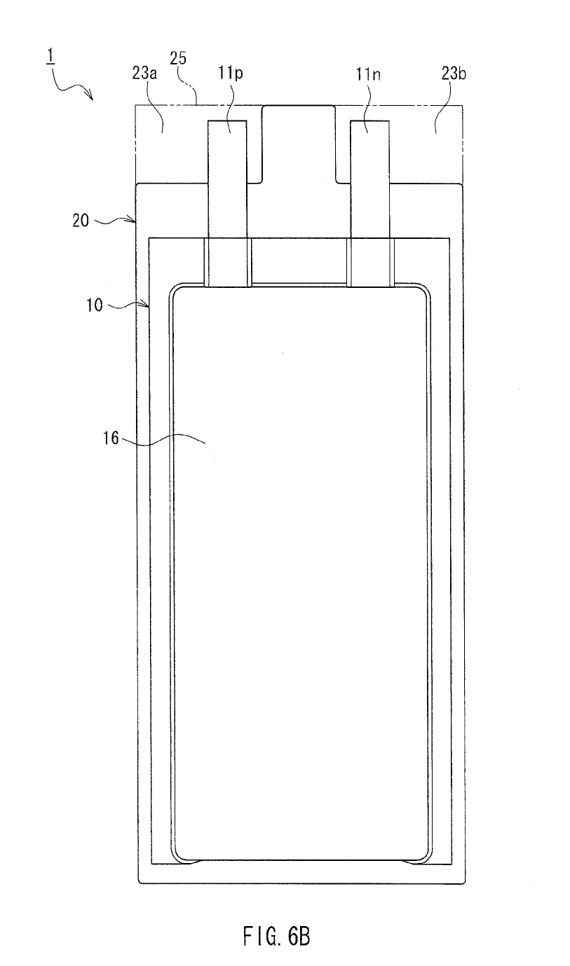

The shape in a plan view of the plates 20 is not limited to the above embodiment as well. For example, as shown in FIG. 6A, the upper edge of the plate 20 may be formed to have a substantially W shape by forming two cut-outs 22a and 22b only in regions that respectively oppose the positive electrode tab 11p and the negative electrode tab 11n of the battery cell 10.

Alternatively, as shown in FIG. 6B, two cut-outs 23a and 23b may be formed in regions that respectively oppose the positive electrode tab 11p and the negative electrode tab 11n of the battery cell 10, the regions being located at the opposite ends of the upper short side of the plate 20.

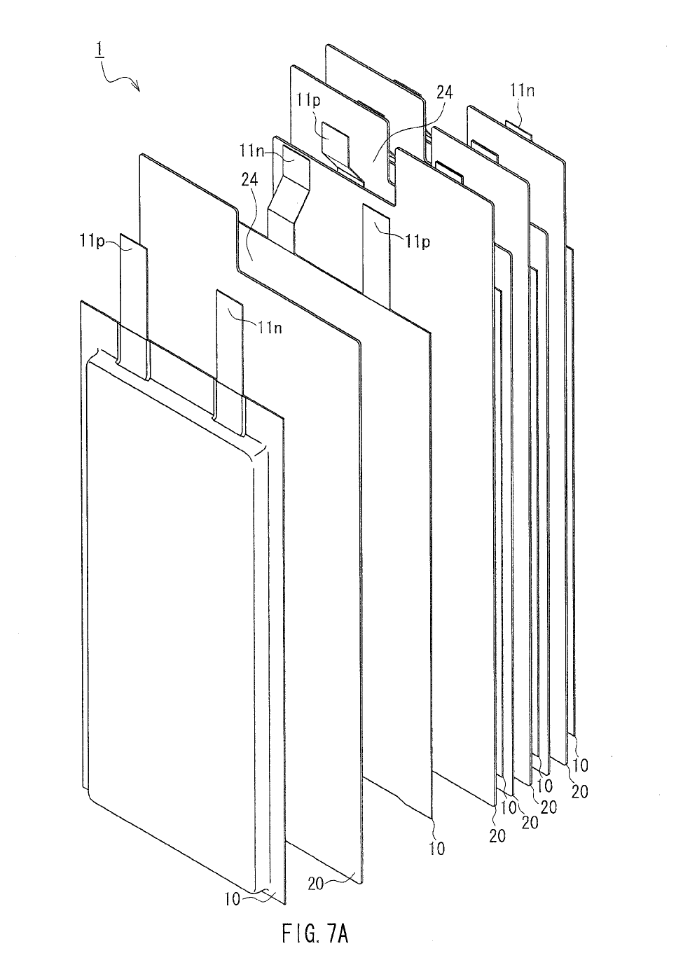

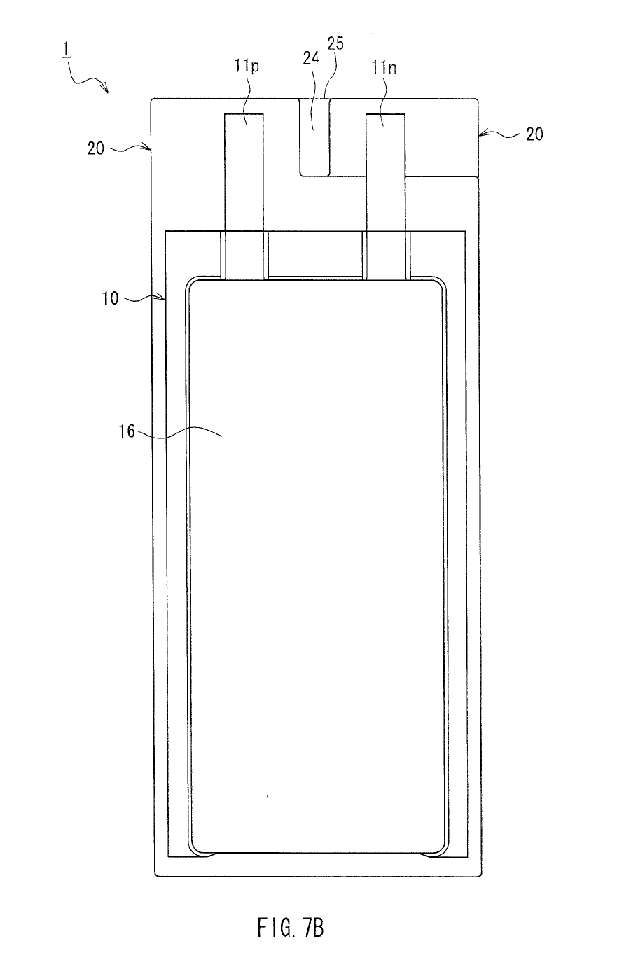

Alternatively, as shown in FIG. 7A, a cut-out 24 may be formed only in a region of each plate 20 where the positive electrode tabs 11p and the negative electrode tabs 11n of two adjacent battery cells 10 that are electrically connected oppose each other. In this example, every other plate 20 having a cut-out 24 formed only in one end portion of the upper short side thereof is flipped over and stacked to the battery cell 10. FIG. 7B is a front view of a battery stack 1 formed in the above-described manner.

In order to electrically connect the positive electrode tab 11p and the negative electrode tab 11n between two battery cells 10 that are adjacent to each other with a plate 20 interposed therebetween, instead of forming a cut-out by partially cutting off a side of the plate 20, a through hole may be formed in the plate 20.

A so-called chamfer may be formed by linearly or arcuately cutting off a corner of the plate 20. Also, a through hole may be formed in the plate 20 as necessary.

Measures may be taken to prevent a short circuit between the positive electrode tab 11p and the negative electrode tab 11n that are not connected but oppose each other in the stacked direction. There is no particular limitation on the measures for preventing a short circuit, and for example, a known method such as covering, with an insulating material, the positive electrode tab 11p and the negative electrode tab 11n that are connected to each other can be used.

The number of battery cells and the number of plates constituting the battery stack are not limited to those of the above embodiment, and can be set to any number.

There is no particular limitation on the application field of the present invention, and the present invention can be widely used as a battery stack for use in a power source for various moving devices such as automobiles, motorbikes and electric power-assisted bicycles, personal digital assistant devices, and uninterruptible power supply (UPS) apparatuses. Particularly, the present invention can be preferably used as a battery stack mounted in various moving devices that easily receive impact and vibrations.

What is claimed is:

1. A battery stack in which a plurality of laminar battery cells and a plurality of plates are alternately disposed and stacked one on top of another,
wherein each of the plurality of battery cells is fixed to an adjacent plate, and
a rectangle with a minimum area internally including the plate also internally includes the battery cell having a positive electrode tab and a negative electrode tab that are drawn out from the battery cell, when the battery stack is viewed in a stacked direction.

2. The battery stack according to claim 1,
wherein in order to allow the positive electrode tab and the negative electrode tab to be electrically connected between adjacent battery cells, a cut-out is formed in a region of the plate to which the positive electrode tab and/or the negative electrode tab are/is opposed.

3. The battery stack according to claim 1,
wherein each side of the rectangle with the minimum area internally including the plate extends 1 mm or more from the battery cell including the positive electrode tab and the negative electrode tab.
